(19) United States
(12) Patent Application Publication
(10) Pub. No.: US 2026/0064933 A1
(43) Pub. Date: Mar. 5, 2026

(54) Multiple Chip Versions From Integrated Design Process

(71) Applicant: Apple Inc., Cupertino, CA (US)

(72) Inventors: John H. Kelm, Belmont, CA (US); Rohit K. Gupta, Santa Clara, CA (US)

(21) Appl. No.: 18/967,288

(22) Filed: Dec. 3, 2024

Related U.S. Application Data
(60) Provisional application No. 63/689,350, filed on Aug. 30, 2024.

(51) Int. Cl. G06F 30/398; G06F 30/327; G06F 30/392; G06F 115/02

(52) U.S. Cl. CPC G06F 30/398; G06F 30/327; G06F 30/392; G06F 2115/02

(57) ABSTRACT

A family of systems-on-a-chip (SOCs) produced using an integrated design methodology is disclosed. The methodology includes defining representations of a plurality of components for a first SOC in a collection of design information, where at least a first component of the plurality of components is modified for inclusion in a second SOC that includes at least a subset of the plurality of components. At least a portion of the collection of design information is parameterized to reflect the first component in the first SOC and the modified first component in the second SOC. Netlists for the first and second SOC are produced from the plurality of source code files using respective first and second sets of parameters.

### CROSS-REFERENCE TO RELATED APPLICATIONS

This application claims priority to U.S. Provisional App. No. 63/689,350 entitled “Multiple Chip Versions from Integrated Design Process,” filed Aug. 30, 2024, the disclosure of which is hereby incorporated by reference in its entirety.

### BACKGROUND

### Technical Field

Embodiments described herein are related to integrated circuits and, more particularly, to a family of integrated circuits produced using an integrated design and development process.

### Description of the Related Art

Integrated circuits include a variety of digital logic circuits and/or analog circuits that are integrated onto a single semiconductor substrate or “chip. ” A wide variety of integrated circuits exist, from fixed-function hardware to microprocessors to systems-on-a-chip (SOCs) that incorporate various functional circuit blocks, such as processor cores, graphics processors, memory controllers, image system processing circuitry, various types of input/output (I/O) circuits as well as circuit blocks that support radio frequency communications, among others. Such SOCs may be formed on a single integrated circuit (IC) or as multiple chips coupled together on a carrier such as a semiconductor substrate or multi-chip module, in what may be called a “chiplet” implementation.

SOCs are used in a wide variety of systems. Some systems which utilize SOCs include smartwatches, mobile devices (e.g., smartphones, tablet computers), television set top boxes, desktop computers, servers, and so on. These various systems may utilize corresponding SOCs that incorporate component configurations and/or levels of functionality in accordance with the needs of their particular application.

### BRIEF DESCRIPTION OF THE DRAWINGS

The following detailed description refers to the accompanying drawings, which are now briefly described.

FIG. 1 is a block diagram illustrating one embodiment of a family of systems-on-a-chip (SOCs).

FIGS. 2A-2B illustrate a sequence of operations for an embodiment of an integrated design process for an SOC family.

FIG. 3 is a block diagram illustrating one embodiment of a first SOC in an SOC family.

FIG. 4 is a block diagram illustrating one embodiment of a second SOC in an SOC family.

FIG. 5 is a block diagram illustrating one embodiment of a first SOC including configuration circuitry.

FIG. 6 is a block diagram illustrating one embodiment of a configuration circuit.

FIG. 7 is a table illustrating one embodiment of a memory address configuration of components of the SOCs of FIGS. 3-5.

FIG. 8 is a flow diagram illustrating one embodiment of a design methodology for an SOC family.

FIG. 9 is a flow diagram illustrating one embodiment of a design methodology for an SOC.

FIG. 10 is a flow diagram illustrating one embodiment of a design methodology for an apparatus incorporating an SOC.

FIG. 11 is a block diagram illustrating example elements of a computing device, according to some embodiments.

FIG. 12 is a block diagram illustrating an example computing device that is usable in various types of systems, according to some embodiments.

FIG. 13 is a block diagram illustrating a computer-readable storage medium storing circuit design information for a computing device, according to some embodiments.

While embodiments described in this disclosure may be susceptible to various modifications and alternative forms, specific embodiments thereof are shown by way of example in the drawings and will herein be described in detail. It should be understood, however, that the drawings and detailed description thereto are not intended to limit the embodiments to the particular form disclosed, but on the contrary, the intention is to cover all modifications, equivalents and alternatives falling within the spirit and scope of the appended claims. The headings used herein are for organizational purposes only and are not meant to be used to limit the scope of the description.

### DETAILED DESCRIPTION OF EMBODIMENTS

As noted above, there is a wide range of system types that an SOC may be used in, such as smartphones, tablets, smart watches, laptop computers, desktop computers, server systems, televisions, set-top boxes, and so forth. These system types have different requirements for SOC components. For example, a server computer or desk-top box may have no need for image processing circuitry to support a camera, while a smartphone would need such circuitry. Moreover, within a given type of system, such as smartphones or laptops, different models may have different performance levels corresponding to requirements for, for example, different numbers of processor cores or different amounts of memory.

The effort to design and fabricate multiple SOCs to support multiple systems can be prohibitive; an organization offering a range of product lines incorporating SOCs may not have sufficient technical workforce to produce different SOCs for the different products. This may particularly be the case when multiple products across the product lines are being developed simultaneously for introduction to the market at the same time.

One approach to providing multiple SOC performance levels without incurring excessive development costs has been to use an older SOC, such as a high-performance SOC from the previous design cycle, as a lower-performance SOC alongside a newly-designed high-performance SOC. Such an older SOC may not be a good match for requirements of certain systems, however, potentially leading to performance degradation such as excess power consumption by unneeded circuits, inefficient power management if, say, an SOC meant for a battery-powered system is used in a plug-in system, or signal degradation caused by noise from unneeded circuits. In addition, using an older SOC may necessitate ongoing effort to support the older design alongside the new one.

Another approach to providing multiple SOC performance levels has been to design and fabricate one fully featured SOC with a full set of the components defined in the SOC architecture, while providing the SOC with configuration circuitry that allows certain components to be disabled in less-featured versions of the SOC. This approach has the disadvantage of producing the most-featured, most expensive SOC for every single product, many of which may not need this level of performance or expense. Still another approach has been to design an integrated circuit (IC) of a fully featured SOC with circuit elements arranged in such a way that a full instance or partial instances of the IC could be taped out by either retaining or removing portions of the layout arranged on end portions of the die. The constraints of positioning any circuit elements to be left out in a portion of the die that can be removed limits the flexibility of this approach, however.

The present disclosure describes embodiments for producing a family of SOCs providing different configurations and/or performance levels corresponding to particular systems a given SOC is to be used in. A family of SOCs as used herein is a group of two or more SOCs sharing a common SOC architecture and developed using an integrated design process. In an embodiment, one SOC in the family includes a first set of components available in the architecture, which may include a particular complement of processor cores and graphics processor cores, a particular set of encoder circuits, and support for a particular range of peripherals. Such an SOC may be suitable for use in a high-performance smartphone or computer system. Another SOC in the family may be designed for use in a lower-performance phone or computer, or a different type of system such as a television. This other SOC may include only a subset of the first set of components or may include modified versions of certain components.

The SOCs in the family share a common architecture expressed in a collection of design information defining a functional design of the SOC implementing the full set of components. In an embodiment, the collection of design information includes source code files such as register-transfer level (RTL) files. “Files” as used herein may in some embodiments be referred to or implemented as modules or other designated collections of code. In addition to source code files defining functional design, the collection of design information may include fixed circuit designs of particular components or circuit elements, sometimes referred to as “Hard IP.” Certain functional blocks, or components, represented in the collection of design information have representations that are parameterized so that applying different parameters when using the design information to generate a gate-level design will result in different circuit configurations providing different functionality and/or performance levels.

In various embodiments, each of the SOCs has its own physical design, but the physical design is constrained so that the SOCs in the family have certain properties in common. For example, the SOCs in the family may have consistent power domain partitioning of corresponding components. The SOCs may be configured to use the same connection fabric in some embodiments. The SOCs may also use the same package. In some embodiments circuit elements implementing corresponding components of the SOCs are in similar locations on their respective chips due to such constraints in the physical design, though not necessarily in the exact same locations. In various embodiments, an SOC implementing fewer and/or modified components has a smaller die size than a fully-featured SOC in the SOC family.

In some embodiments, use of the same set of parameterized design information to design the multiple SOCs in the family allows a first SOC to be designed, verified, taped out and tested, with one or more additional SOCs then being able to rely on results from that verification and testing. In such embodiments, multiple different SOCs in the family may be able to be designed and fabricated for not much more effort than is needed for the first SOC. To avoid duplication of software development work for the multiple SOCs, the different SOCs are configured to boot up using the same read-only memory (ROM) in some embodiments. The different SOCs may also use the same memory map, retaining address allocations even for components not present in a given SOC. Two or more of the different SOCs in the family may also present the same chip identifier to higher-level software applications in some embodiments. In some embodiments, the SOC architecture includes configuration circuitry allowing a more fully featured SOC to be built and then configured to exhibit the capability of an SOC having fewer and/or modified components. Such an SOC may be used as a development SOC for development of systems using the less-featured SOC at a time when only the more-featured SOC has been fabricated.

A “component” of an SOC as used herein refers to a portion of the SOC, such as a processor such as a CPU or GPU, a cluster of processors or GPUs, a memory controller or set of memory controllers, a communication fabric or portion thereof, a peripheral device or peripheral interface circuit, etc. A component may be said to include or to be implemented by circuitry of the SOC. A given component may have a hierarchical structure in some embodiments. For example, a processor cluster component may include multiple instances of a processor component, which may be copies of the same processor design placed multiple times within the area occupied by the cluster.

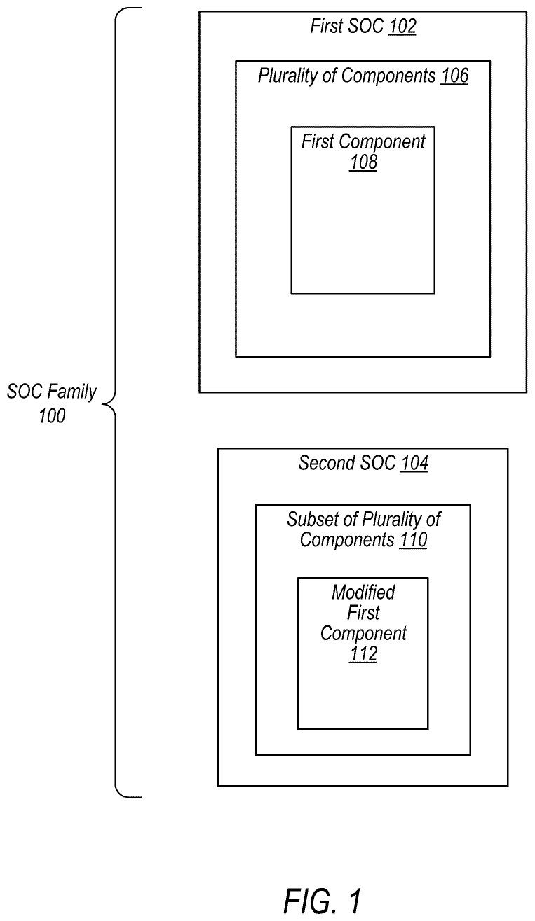

FIG. 1 is a block diagram illustrating certain features of one embodiment of an SOC family. SOC family 100 includes first SOC 102 and second SOC 104. First SOC 102 includes circuitry implementing a plurality 106 of components, including a first component 108. Second SOC 104 includes circuitry implementing a subset 110 of the plurality 106 of components implemented by first SOC 102. Subset 110 includes a modified version 112 of first component 108. In an embodiment, modified version 112 has reduced functionality compared to first component 108. For example, if first component 108 is a cluster of processor cores, modified version 112 may be a cluster containing fewer processor cores than the number in first component 108. As another example, if first component 108 is a cache memory, modified version 112 may be a smaller cache memory.

SOCs within SOC family 100 share a common architecture defined at a functional level by a common collection of design information, where the design information is parameterized to allow different versions of certain components to be implemented depending on the parameters used in generating a gate-level design. In an embodiment, modified version 112 of first component 108 is implemented in second SOC 104 by using a different set of parameters than those used to implement first component 108 in first SOC 102. FIG. 1 is a simplified representation, and various extensions and modifications will be understood by one of ordinary skill in the art of integrated circuit design. For example, other components in addition to first component 108 Could Be Modified in Second Soc 104. an Soc Family May Include More Than Two SOCs in other embodiments. For example, first component 108 may be modified in different ways, using different sets of parameters, to implement additional SOCs. Different SOCs may also implement modifications of different components than first component 108.

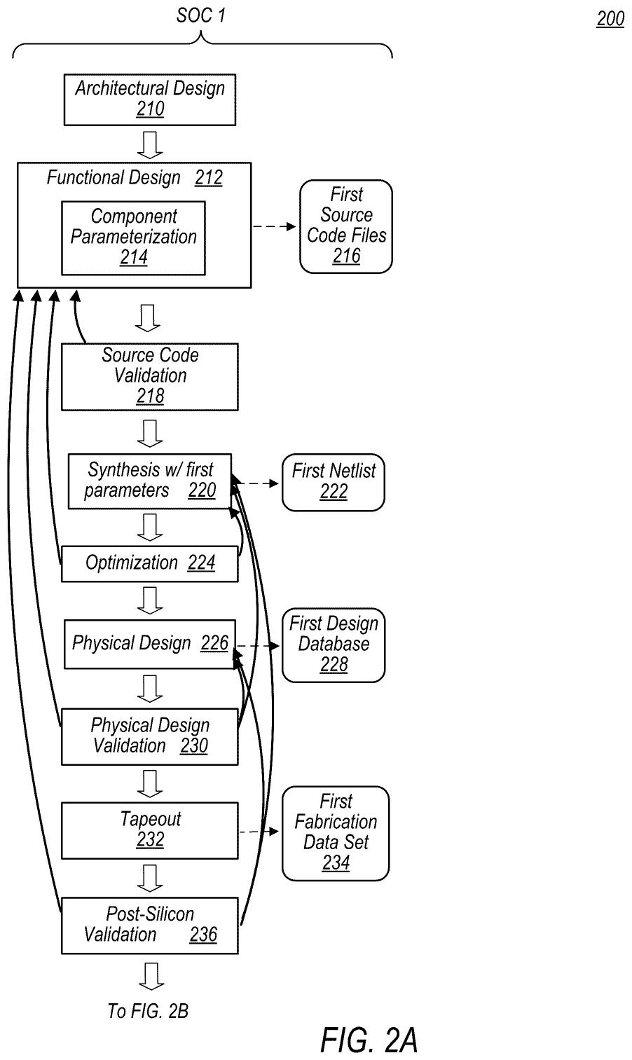

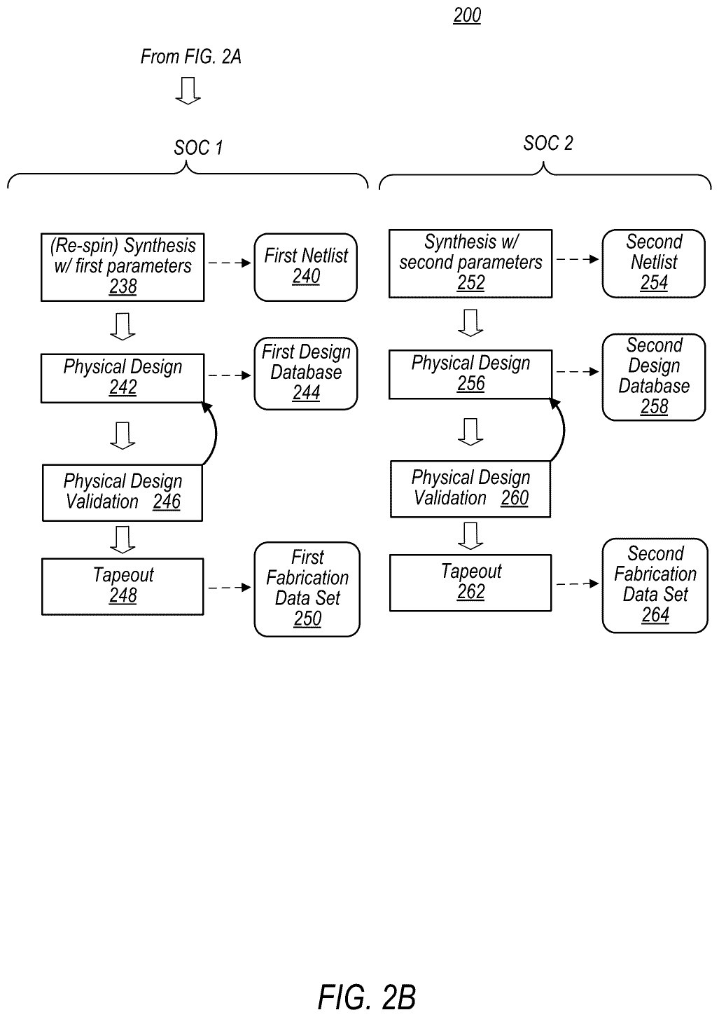

FIGS. 2A and 2B illustrate a sequence of operations for an embodiment of an integrated design process for an SOC family. As suggested by upward-directed arrows between certain blocks of FIG. 2A, parts of process 200 may be repeated as part of the overall design flow. Process 200 is initially directed to a first SOC, “SOC 1,” as shown by the bracket at the top of the diagram. Architectural design 210 includes deciding on the high-level overall design that will be shared by the SOCs in the family. In various embodiments, this high-level design includes the types of processors, memories and memory controllers used, the types of peripherals supported, and the nature of the interconnection fabric interconnecting the elements of the SOC. In particular, in some embodiments, the same interconnection fabric topology is seen by software for each SOC in the family. In an embodiment, architectural design 210 describes a superset of the components needed for all SOCs in the family. In the embodiment of FIG. 2A, functional design 212 represents the various components of this SOC design superset at a functional level using first source code files 216, or source code files corresponding to the first SOC. In other embodiments, functional design 212 is defined using HardIP such as input/output cells or analog components in addition to source code files such as files 216. In an embodiment, functional design 212 describes the design in terms of data flow between registers and logic operations performed on the data, and the source code files are register-transfer level (RTL) files. Such RTL files may include descriptions of components of the SOC expressed in a hardware description language (HDL) such as Verilog, VHDL, etc. Other types of source code files may be used for the functional design in other embodiments.

Functional design 212 includes component parameterization 214. Component parameterization 214 includes defining representations of certain components of the SOC design in terms of parameters that will allow those components to be modified for implementation in different SOCs within the family. Component parameters may include, for example, a number of processor cores in a processor cluster or a size of a cache memory in some embodiments. A parameter may also reflect whether or not a particular component is included in a given SOC at all. Process 200 also includes source code validation 218. In various embodiments, source code validation 218 includes various types of testing and refinement of first source code files 216 and/or other elements of design information defining functional design 212. For example, source code validation 218 may include one or more of optimization, simulation or verification of first source code files 216, where optimization may be directed to various properties such as speed, power consumption or area of the described design. Validation 218 may result in changes to or repetition of some or all of the functional design process 212 and to the content of first source code files 216, as indicated by an upward arrow shown in FIG. 2A, between the blocks for validation 218 and functional design 212.

Process 200 further includes synthesis operation 220 using a first set of parameters. Synthesis 220 includes a derivation of a first netlist 222 from first source code files 216. First netlist 222 is a lower-level description of the circuitry for SOC 1, which may be at a gate, device or transistor level in some embodiments. In an embodiment, first netlist 222 describes circuit elements using a library of standard cells. Synthesis 220 is performed using a first set of parameters for components having representations that are parameterized in first source code files 216. This first set of parameters results in a first netlist 222 having a circuit configuration specific to SOC 1. In an embodiment, synthesis 220 performs a translation of source code files 216 into first netlist 222. In the embodiment of FIG. 2A, Synthesis 220 is followed by optimization phase 224. In various embodiments, optimization 224 may include various types of testing, such as simulation to verify correct operation of the circuit configuration specified by first netlist 222 or optimization of signal timing in the circuit configuration. Results of optimization 224 may prompt changes to or repetition of some or all of synthesis 220, resulting in changes to first netlist 222. In some embodiments, results of optimization 224 may be fed back to functional design process 212.

Process 200 further includes physical design 226. Physical design 226 includes generation of a first design database 228 including physical layout descriptions of the circuit elements described in first netlist 222 and the interconnections between these elements. Physical design 226 in various embodiments includes automated and/or manual layout processes. Process 200 further includes physical design validation 230. Physical design validation 230 includes, in various embodiments, various verification and validation checks of the layout generated by physical design process 226. Results of physical design validation 230 may prompt changes to or repetition of some or all of physical design 226, in turn resulting in changes to first design database 228. In some embodiments, results of validation 230 may be fed back to synthesis process 220 and/or functional design process 212. In various embodiments, first design database 228 may include, in addition to physical layout descriptions, data from other stages of process 200. For example, first design database 228 may also include some or all of first source code files 216, first netlist 222, or first fabrication data set 234. In some embodiments, first design database 228 may be part of a larger design database including design data for other SOCs in the SOC family, in addition to SOC 1.

Process 200 further includes tapeout process 232, in which first fabrication data set 234 is generated. First fabrication data set 234 includes data to be used by an IC fabrication facility to fabricate SOC 1. In an embodiment, first fabrication data set 234 includes tapeout description files which describe SOC 1 in terms of geometric shapes and layers that can be used to create masks for the integrated circuit fabrication process. Depending on whether SOC 1 is implemented as a single IC or a group of ICs, first fabrication data set 234 may include descriptions for making masks for a single IC or for multiple ICs. In various embodiments, data within first fabrication data set 234 may be expressed in various graphics formats such as graphic design system (GDSII) format or open artwork system interchange standard (OASIS) format.

For fabrication of SOC 1, first fabrication data set 234 is transmitted to an IC fabrication facility, which prepares masks and fabricates instances of SOC 1. Once SOC 1 is fabricated, one or more of the manufactured SOCs can be tested during post-silicon validation 236. In various embodiments, post-silicon validation includes various simulations and tests done in a laboratory environment to verify the SOC will operate as intended when incorporated into a system. If SOC 1 passes post-silicon validation 236, the design process for SOC 1 ends. If problems are detected during validation 236, some or all of functional design 212, synthesis 220 or physical design 226 may need to be repeated with modifications, in a process often called a re-spin.

An embodiment of a re-spin process for SOC 1 as process 200 continues is illustrated in FIG. 2B. The re-spin includes a repeated synthesis process 238 using the first set of parameters, producing first netlist 240. In an embodiment, synthesis 238 is done using an updated set of first source code files 216, where the updating of first source code files 216 is caused by feedback from post-silicon validation 236 or from any other testing and validation procedures performed subsequent to the last synthesis performed for SOC 1 prior to tapeout 232. The re-spin continues with a repeated physical design process 242 based on newly updated first netlist 240. Physical design process 242 results in an updated version of first design database 244, which is tested during physical design validation process 246. A repeated tapeout process 248 is then performed to produce an updated first fabrication data set 250. Although not shown in FIG. 2B, fabrication of SOC 1 can then proceed by transmitting first fabrication data set 250 to an IC fabrication facility for fabrication. Instances of the resulting fabricated SOC 1 could then be tested, and further re-spins implemented if necessary.

In parallel with the re-spin of the SOC 1 design process, integrated design process 200 includes a design process for SOC 2. Synthesis process 252 is performed to produce a second netlist 254 for SOC 2. Synthesis process 252 is similar to synthesis 220 and 238 for SOC 1, except that synthesis 252 uses a second set of parameters different from the first set of parameters used to produce the netlist for SOC 1. In some embodiments, portions of the netlist for SOC 2 that are not affected by the parameterization are copied from the netlist of SOC 1 rather than being strictly “synthesized” again. Synthesis 252 derives second netlist 254 from the most recent version of first source code files 216 using the second set of parameters for parameterized component representations in first source code files 216. In an embodiment, the most recent version of first source code files 216 is an updated version compared to the version used in synthesis process 220 for SOC 1, because of the validation, optimization, and testing processes carried out during the design of SOC 1.

In the embodiment of FIG. 2B, physical design 256 is performed using second netlist 254 without intervening testing of second netlist 254. In an embodiment, portions of the physical design that are not affected by use of the second set of parameters are copied from the physical design of SOC 1 rather than being generated using corresponding portions of the second netlist. In some embodiments, the testing and revisions previously performed in connection with design of SOC 1 are sufficient to eliminate the need for further testing before physical design of SOC 2. In other embodiments, some testing, optimization or validation of second netlist 254 is performed, but this may be more limited testing than was required during the design of SOC 1. In various embodiments, the need for additional testing may depend on factors such as the type of parameters changed for synthesis of SOC 2 compared to SOC 1, whether the resulting circuit differences are likely to affect logical function of the SOC, and physical partitioning and shapes of components on the die.

In the embodiment of FIG. 2B, physical design 256 is followed by physical design validation 260 for testing the layout described in second design database 258 for SOC 2. In an embodiment, physical design validation 260 is limited to areas of the SOC 2 layout that are different from the layout of SOC 1. In some embodiments, physical design validation 260 may not be necessary in view of previous physical design validation during the design of SOC 1. Process 200 further includes tapeout process 262, in which second fabrication data set 264 is generated. Second fabrication data set 264 is similar to first fabrication data sets 234 and 250, except that second fabrication data set 264 includes data to be used by an IC fabrication facility to fabricate SOC 2. Although not shown in FIG. 2B, fabrication of SOC 2 can then proceed by transmitting second fabrication data set 264 to an IC fabrication facility for fabrication.

As shown and described, process 200 of FIGS. 2A-2B is an embodiment of an integrated design process for an SOC family including SOC 1 and SOC 2. SOC 1 and SOC 2 are similar to first SOC 102 and second SOC 104, respectively, or SOC family 100 of FIG. 1. By parameterizing design information so that the same set of design information can be used to generate netlists for multiple SOCs, process 200 may allow the SOC 2 design process to benefit from testing and validation processes performed during the design of SOC 1, thereby allowing SOC 2 to be produced by an abbreviated process as compared to SOC 1. In an embodiment for which one re-spin of the first SOC is required and no re-spin of the second SOC is required, as shown in FIGS. 2A-2B, the two SOCs can be completed at the same time but with significantly less effort than would be required to design two separate SOCs.

The embodiment of FIGS. 2A-2B is merely one example of an integrated design process for a family of SOCs, and multiple modifications and extensions will be understood by one of ordinary skill in the art of integrated circuit design. For example, other design processes may include more or fewer testing, validation or optimization stages than those shown in FIGS. 2A-2B, or the testing, validation or optimization stages may be distributed differently among stages of design process 200. In some embodiments, synthesis of SOC 2 could be performed in parallel with an earlier stage of the design of SOC 1, rather than in parallel with a re-spin process. For example, there are multiple stages in the design of SOC 1 at which synthesis of SOC 2 could benefit from previous updating of first source code files 216 due to feedback from stages such as optimization 224 or physical design validation 230. Although design of two SOCs is illustrated by process 200, a larger number of SOCs could be designed in an integrated process in other embodiments. For example, a synthesis process for a third SOC could be performed, using a third set of parameters for parameterized component representations in first source code files 216, to generate a third netlist. This synthesis could be performed in parallel with synthesis 252 for SOC 2, or at an earlier or later point in the integrated design process.

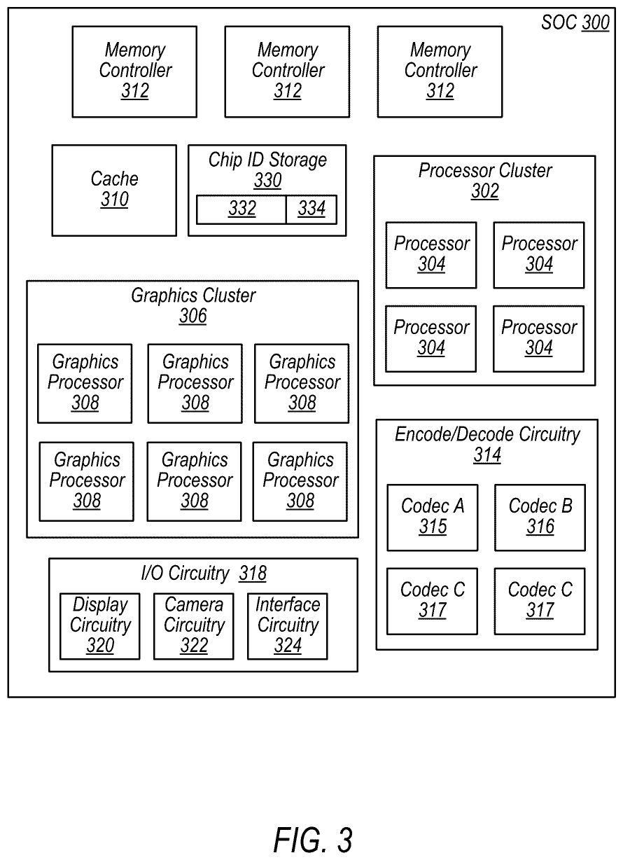

FIG. 3 is a block diagram illustrating certain elements of one embodiment of a first SOC in an SOC family. As shown, SOC 300 includes circuitry implementing a processor cluster 302 having four processors 304, and a graphics cluster 306 having six graphics processors 308. SOC 300 also implements cache memory 310 and three memory controllers 312 configured for connection to external memory. In addition, SOC 300 implements encode/decode circuitry 314, including encode/decode (“codec”) circuits 315, 316 and 317 implementing a codec A, codec B and two codecs C. In an embodiment, codecs A, B and are codec circuits for particular image or video formats, such as Joint Photographic Experts Group (JPEG) or High Efficiency Video Encoding (HEVC). SOC 300 further includes I/O circuitry 318 for supporting various peripheral devices and interfaces, wherein circuitry 318 includes display circuitry 320, camera circuitry 322 and interface circuitry 324. Additional interface characteristics not specifically shown that may be varied for different SOCs within a family include, for example, a number of lanes in a bus such as a Peripheral Component Interconnect Express (PCIe) bus or a number of general-purpose input/output (GPIO) pins used. Other examples include types of display interfaces, such as DisplayPort or Mobile Industry Processor Interface (MIPI), or a number of lanes used with a given interface. As yet another example, different physical interfaces may be implemented on different SOCs within a family, such as use of USB2 and USB3 in one SOC and only USB2 in another.

SOC 300 also includes chip ID storage 330 for storing an identifier for the SOC used by software applications. In the embodiment of FIG. 3, chip ID storage 330 includes primary ID storage 332 and auxiliary ID storage 334. Primary ID storage 332 stores an identifier for SOC 300 that is accessed by most software using SOC 300. In an embodiment, the identifier stored by primary ID storage 332 is also the identifier used by a boot ROM for SOC 300. In some embodiments disclosed herein, primary ID storage 332 stores the same value for all SOCs in the same SOC family. Auxiliary ID storage 334 stores an additional identifier accessed only by certain special-purpose configuration software for SOC 300. In some embodiments, auxiliary ID storage 334 stores additional identifiers that have different values for the different SOCs in an SOC family. In an embodiment, primary ID storage 332 and auxiliary ID storage 334 are in the form of set of fuses representing respective bits of the stored identifiers. Boot code for SOC 300 may read such fuses and store a value of at least the primary ID in a register or other memory location.

SOC 300 of FIG. 3 is a simplified representation of certain elements of an SOC for illustrative purposes. Multiple additional circuits and structures not shown in FIG. 3 are included in embodiments of SOCs contemplated herein. For example, embodiments of an SOC include power control circuitry not shown in FIG. 3. Such power control circuitry provides power to the circuitry implementing the various components of SOC 300. Power circuitry of SOC 300 may also establish power domains within SOC 300, where circuitry within a given power domain uses the same power supply and can be switched on or off together. In some embodiments disclosed herein, SOCs within an SOC family are constrained to use the same power domain partitioning for corresponding components. As another example, SOC 300 also includes an interconnection fabric, not shown in FIG. 3, for interconnecting the circuitry implementing the various components of SOC 300. In various embodiments, this interconnection fabric defines locations of external connections to the one or more semiconductor die forming the SOC and constrains the size and configuration of a package that can house the SOC. In some embodiments of an SOC family as disclosed herein, the same interconnection fabric topology is seen by software for every SOC in the family, though the connected components of the topology are implemented only partially by any given SOC. In some embodiments disclosed herein, SOCs within an SOC family are constrained to be compatible with the same package configuration. Such a package configuration may be for the SOC package in some embodiments. In additional embodiments, SOCs within a family are constrained to be compatible with additional packages as well, such as a DRAM package connected to the SOC or an overall package for a larger system (“system-in-package,” or SIP). In various embodiments, some or all of the physical design constraints described herein may be imposed in combination.

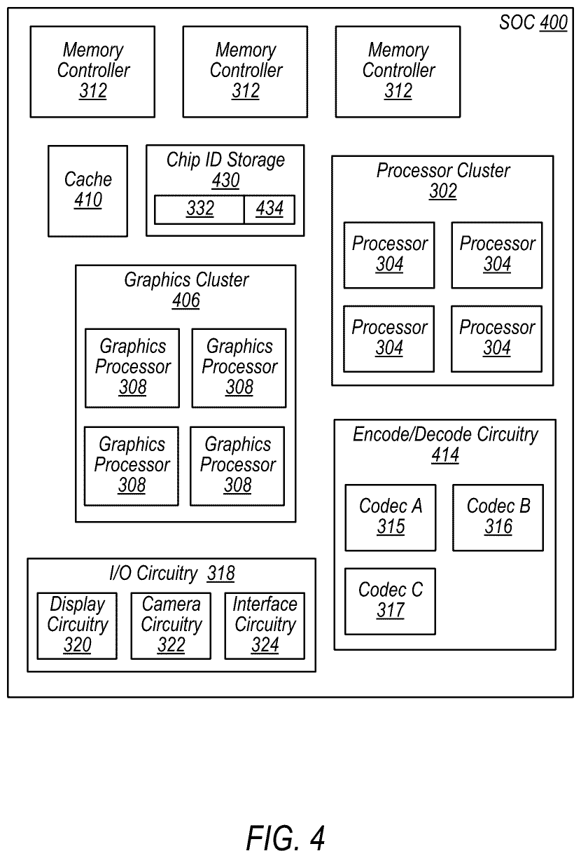

FIG. 4 is a block diagram illustrating certain elements of one embodiment of a second SOC in the same SOC family as SOC 300 of FIG. 3. As shown, SOC 400 of FIG. 4 implements many of the same circuits and components as SOC 300 of FIG. 3, but certain components and circuits of SOC 300 are missing or modified in SOC 400. For example, graphics cluster 406 of SOC 400 includes four of graphics processor 308, while graphics cluster 306 of SOC 300 includes six of graphics processor 308. Cache 410 of SOC 400 is depicted using a smaller block to indicate that the storage capacity of cache 410 is smaller than that of cache 310 of SOC 300. In addition, encode/decode circuitry 414 of SOC 400 includes a single instance of codec C circuit 317, while encode/decode circuitry 314 of SOC 300 includes two instances of this codec C circuit. In an embodiment, chip ID storage 430 of SOC 400 stores the same primary chip ID value in primary ID storage 332, but a different auxiliary chip ID value in auxiliary ID storage 434. In an embodiment, SOC 300 and SOC 400 are designed using an integrated design process similar to process 200 of FIGS. 2A-2B, where a set of parameters used to synthesize the circuitry of SOC 400 includes parameters for setting the number of graphics processors to four, setting the cache 410 to a smaller storage size, setting the number of codec C circuits to one, and storing a value in auxiliary ID storage 434 appropriate for SOC 400.

In some embodiments, the reduced number of components and smaller cache size implemented in SOC 400 may allow a smaller die size to be used within SOC 400. Constraints to the physical design of SOCs within a family may limit the degree to which area can be optimized, however. As illustrated in FIGS. 3-4, corresponding components of SOC 300 and SOC 400 are in various embodiments positioned in similar areas of their respective SOCs (whether the SOCs are implemented using a single die or a collection of die). These similar physical locations may result, in various embodiments, from various physical design constraints. In some embodiments, SOC 400 is constrained to use the same interconnection fabric as SOC 300. SOC 400 may also be constrained to use the same power domain partitioning as SOC 300 in various embodiments. In some embodiments SOC 400 is constrained to be compatible with the same package configuration as SOC 300. The component configuration implemented by SOC 400 is merely one example, and any number of other modifications may be implemented in embodiments of SOCs within a given SOC family.

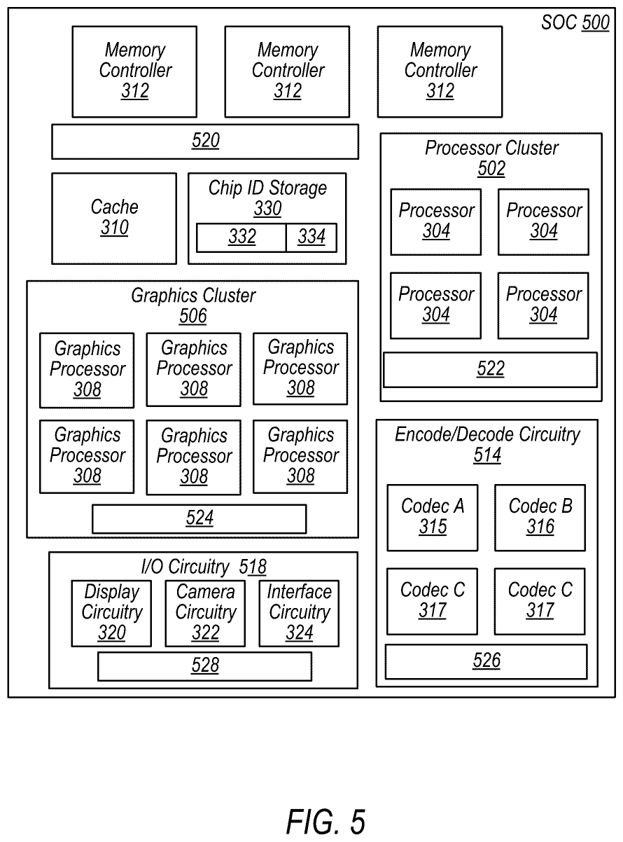

FIG. 5 is a block diagram illustrating certain elements of one embodiment of a first SOC in an SOC family, where the first SOC includes configuration circuitry. SOC 500 of FIG. 5 implements the same components as SOC 300 of FIG. 3 and also includes additional configuration circuits 520, 522, 524, 526 and 528. These configuration circuits allow components or circuits of SOC 500 to be selectively disabled. For example, configuration circuit 520 is operable to allow one or more of memory controllers 312 to be disabled or a portion of cache 310 to be disabled. Configuration circuit 522 is operable to allow one or more of processors 304 within processor cluster 502 to be selectively disabled. Similarly, configuration circuit 524 is operable to allow one or more of graphics processors 308 within graphics cluster 506 to be disabled. Configuration circuit 526 is operable to allow one or more of the codec circuits in encode/decode circuitry 514 to be disabled, and configuration circuit 528 is operable to allow one or more of display circuitry 320, camera circuitry 322 or interface circuitry 324 to be disabled.

A potential application of the ability to selectively disable components of SOC 500 is that a manufactured instance of SOC 500 can in some embodiments be configured to have the functionality of a different SOC within the same SOC family by disabling certain components. For example, SOC 500 could be configured to have the capability of SOC 400 of FIG. 4 through the use of configuration circuit 520 to reduce the capacity of cache 310, the use of configuration circuit 524 to disable two of graphics processors 308, and the use of configuration circuit 526 to disable one of codec C circuits 317. With reference to an integrated design process like that of FIGS. 2A-2B, a manufactured instance of SOC 1 of process 200 configured to have the capability of SOC 2 of process 200 could be used for development and testing of systems designed to use SOC 2 at a point in process 200 when SOC 2 has not been manufactured yet. In embodiments for which both SOC 1 and SOC 2 present the same chip ID to software used by a system based on SOC 2, switching from the modified SOC 1 development SOC to an actual manufactured instance of SOC 2, once available, may not require any changes to the software of the system.

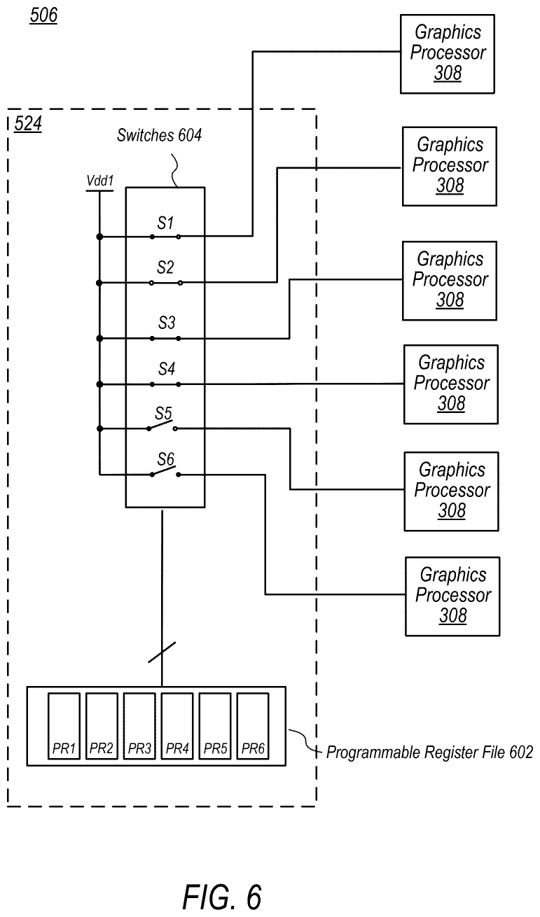

FIG. 6 is a block diagram illustrating certain elements of one embodiment of a configuration circuit. In particular, an embodiment of configuration circuit 524, of graphics cluster 506 in FIG. 5, is illustrated. As shown, circuit 524 in this embodiment includes a programmable register file 602 coupled to a set of switches 604. Each of the switches is connected between a power supply voltage node Vdd1 and a respective one of graphics processors 308 of graphics cluster 506. In the example of FIG. 6, the programmable registers within programmable register file 602 are programmed such that switches S5 and S6 are opened, thereby removing power from two of the six instances of graphics processor 308 within graphics cluster 506.

FIG. 6 illustrates merely one example of a configuration circuit and other mechanisms may be used in other embodiments. For example, disabling of circuits or components may also be done by selectively removing clock signals from certain circuits or components (clock gating) rather than by power gating, or combinations of these approaches. In some embodiments, programmable registers such as those of FIG. 6 may be implemented using fuses. Configuration circuits such as those of FIG. 5 are in some embodiments similar to circuits used to disable certain circuit elements that have been found defective through testing, or to disable components of SOCs for use in systems not requiring those components. Such “harvesting” techniques may in some embodiments be implemented for SOCs produced using integrated design processes for SOC families as disclosed herein.

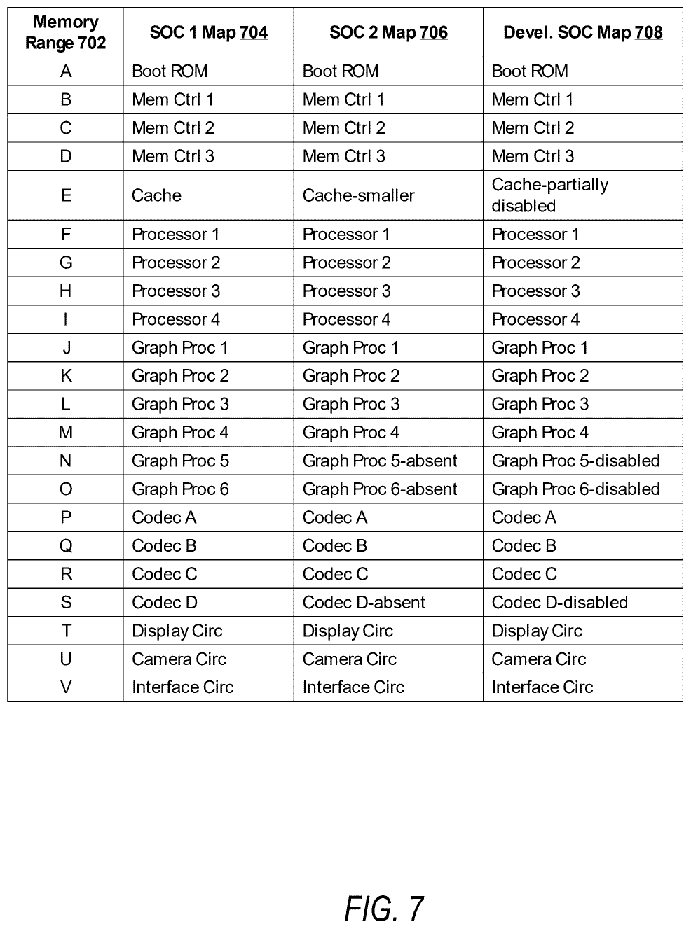

FIG. 7 is a table illustrating one embodiment of a memory address configuration of components of the SOCs of FIGS. 3-5. In some embodiments, SOCs within the same SOC family use the same memory map, whether or not a given SOC actually implements all of the components having memory address ranges assigned. The table of FIG. 7 illustrates this type of memory address mapping for a set of SOCs corresponding to those shown in FIGS. 3-5. Memory address ranges 702 are denoted by letters for simplicity. Column 704 includes assigned component or circuit descriptions for SOC 1 of the SOC family, where in the illustrated embodiment SOC 1 corresponds to SOC 300 of FIG. 3. Column 706 includes assigned component or circuit descriptions for SOC 2 of the SOC family, where in the illustrated embodiment SOC 2 corresponds to SOC 400 of FIG. 4. Column 708 includes assigned component or circuit descriptions for a development SOC formed by configuring a fabricated instance of SOC 1 to have the functionality of SOC 2. As shown, all of the SOCs have the same component or circuit assigned to a given memory range. In the case of SOC 2, column 706 shows that certain components are either missing or modified. As shown in column 708, the same components that are missing or modified in SOC 2 are disabled or partially disabled in the development SOC. Although in the embodiment shown SOC 2 includes a subset of the components in SOC 1, in other embodiments one or more components present in the map of SOC 2 could be absent in the map of SOC 1.

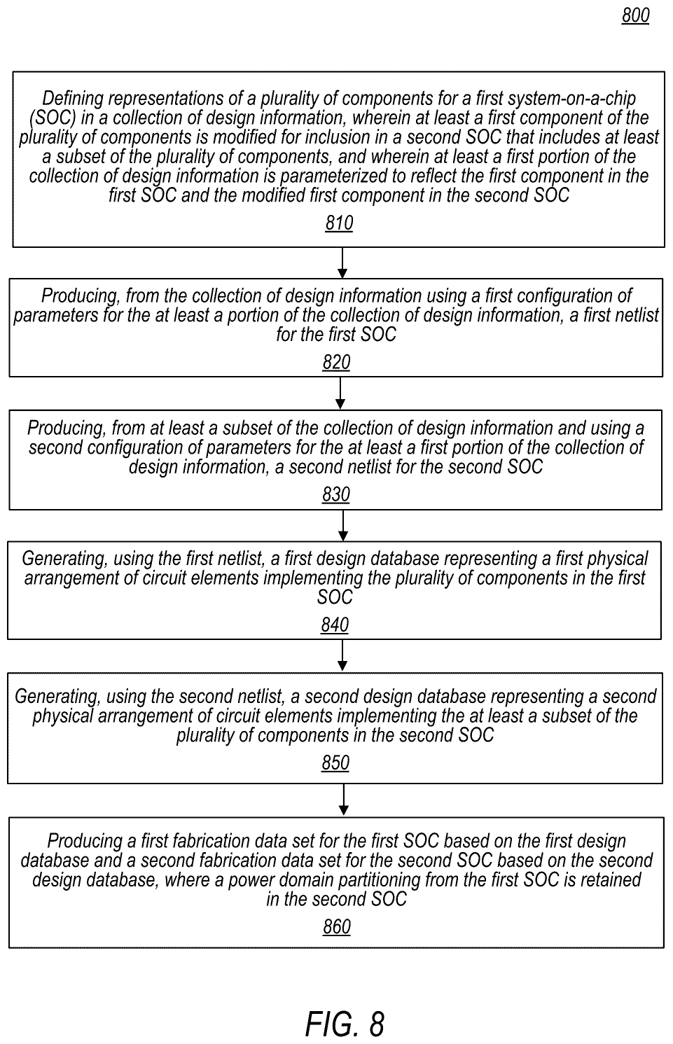

FIG. 8 is a flow diagram illustrating an example of an SOC design method. Method 800 is one embodiment of a method that may be performed by a computer system. Other embodiments of a method may include more or fewer blocks than shown in FIG. 8. Method 800 includes, at block 810, defining representations of a plurality of components for a first SOC in a collection of design information, wherein at least a first component of the plurality of components is modified for inclusion in a second SOC that includes at least a subset of the plurality of components. At least a first portion of the collection of design information is parameterized to reflect the first component in the first SOC and the modified first component in the second SOC. In one embodiment, the first component is a memory circuit, and the modified first component has a smaller storage capacity than the first component. Such a memory circuit may include, for example, one or more of a static random-access memory (SRAM) on the SOC, a cache memory size the SOC is configured to use, or a number of DRAM channels the SOC is configured to use. In another embodiment, the first component is a cluster of processor cores, which may be graphics processor cores, and the modified first component includes a smaller number of processor cores than the first component. In still another embodiment, the first circuit component is a group of encoder circuits, and the modified first component includes a smaller number of encoder circuits than the first component. The first component and modified first component may include multiple other components of an SOC in other embodiments, including but not limited to components described in connection with FIGS. 3-5.

Method 800 also includes (block 820) producing, from the collection of design information using a first configuration of parameters for the at least a first portion of the collection of design information, a first netlist for the first SOC. In addition, method 800 includes (block 830) producing, from at least a subset of the collection of design information using a second configuration of parameters for the at least a first portion of the collection of design information, a second netlist for the second SOC. In some embodiments, the collection of design information includes a plurality of source code files such as register-transfer level (RTL) files. In such an embodiment, producing the first and second netlists may include synthesizing the netlists from the plurality of RTL files using a synthesis tool.

Method 800 also includes (block 840) generating, using the first netlist, a first design database representing a first physical arrangement of circuit elements implementing the plurality of components in the first SOC. In addition, the method includes (block 850) generating, using the second netlist, a second design database representing a second physical arrangement of circuit elements implementing the at least a subset of the plurality of components in the second SOC. Method 800 also includes, at block 860, producing a first fabrication data set for the first SOC based on the first design database and a second fabrication data set for the second SOC based on the second design database, where a power domain partitioning from the first SOC is retained in the second SOC.

In some embodiments of method 800, the first physical arrangement includes one or more configuration circuits allowing changes to be made to the first SOC to implement in the first SOC the modified first component. In such an embodiment, an SOC design method may further include transmitting the first fabrication data set for the first SOC to a manufacturing system for manufacture of the first SOC, and using the one or more configuration circuits to modify a manufactured instance of the first SOC to produce a development SOC reflecting a component configuration of the second SOC. Such a development circuit may be used for development of a system incorporating the second SOC at a stage of the design process when the second SOC has not yet been manufactured.

In some embodiments of method 800, a first chip identifier reported by the first SOC in response to execution of a chip identifier software instruction has a same value as a second chip identifier reported by the second SOC in response to execution of the chip identifier software instruction. In an alternative embodiment, the chip identifiers reported by the first and second SOC are the same, but the power domain partitioning from the first SOC is not necessarily retained in the second SOC.

In some embodiments of method 800, the first physical arrangement provides for external connections, to the circuit elements implementing the plurality of components, at locations in the first SOC consistent with locations in the second SOC of external connections, to the circuit elements implementing the at least a subset of the plurality of components, provided for by the second physical arrangement. Such consistency of locations of external connections may allow the first and second SOCs to be compatible with the same package configuration. In an alternative embodiment, locations of external connections are consistent between the first and second SOCs, but the power domain partitioning from the first SOC is not necessarily retained in the second SOC.

In various embodiments, method 800 further includes transmitting one or both of the first fabrication data set and the second fabrication data set to an IC fabrication facility for fabrication of the first and/or second SOCs. Embodiments may further include performing testing of one or both of the fabricated first and second SOCs. Embodiments may further include system development based on one or both of the first and second SOCs.

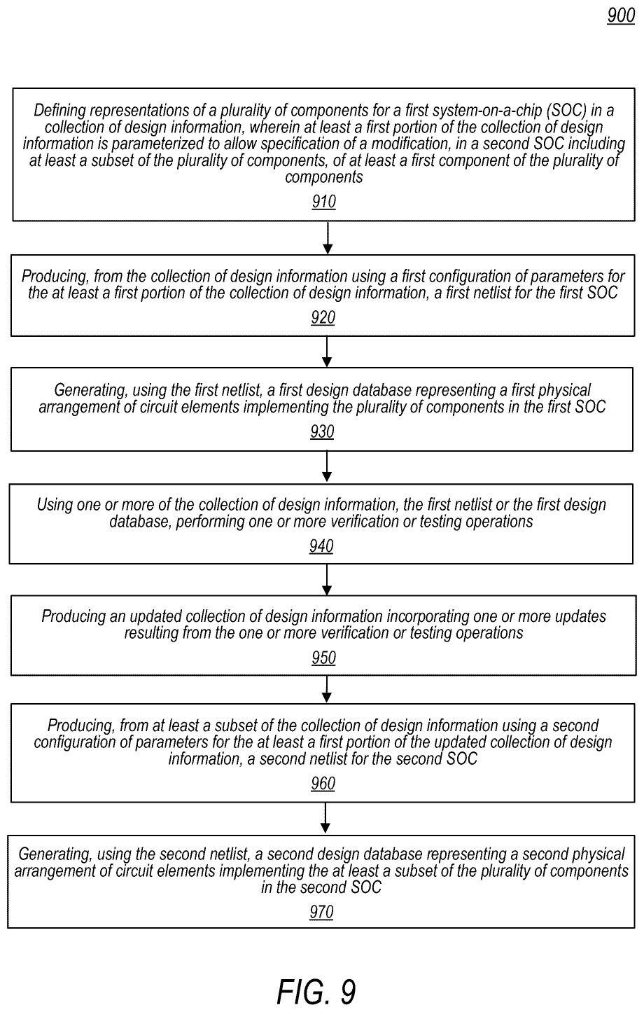

FIG. 9 is a flow diagram illustrating an example of an SOC design method. Method 900 is one embodiment of a method that may be performed by a computer system. Other embodiments of a method may include more or fewer blocks than shown in FIG. 9. Method 900 includes, at block 910, defining representations of a plurality of components for a first SOC in a collection of design information, wherein at least a first portion of the collection of design information is parameterized to allow specification of a modification, in a second SOC including at least a subset of the plurality of components, of at least a first component of the plurality of components. In one embodiment, the modification of at least a first component includes a reduction in an amount of memory. Such an amount of memory may include, for example, one or more of a cache size, an amount of dedicated SRAM on the SOC or a number of DRAM channels in various embodiments. In another embodiment, the modification of at least a first component includes a reduction in a number of processor cores. In other embodiments, the modification of at least a first component includes a reduction in a number of encoder/decoder circuits or peripheral support circuits. The modification of at least a first component may include modification of other components of an SOC in other embodiments of method 900.

Method 900 also includes (block 920) producing, from the collection of design information using a first configuration of parameters for the at least a first portion of the collection of design information, a first netlist for the first SOC. In an embodiment, the collection of design information includes a plurality of source code files such as RTL files. In such an embodiment, producing the first netlist may include synthesizing the netlist from the plurality of RTL files using a synthesis tool. Method 900 also includes (block 930) generating, using the first netlist, a first design database representing a first physical arrangement of circuit elements implementing the plurality of components in the first SOC.

Method 900 further includes, at block 940, performing one or more verification or testing operations using one or more of the collection of design information, the first netlist or the first design database. Some examples of verification or testing operations are described above in connection with process 200 of FIGS. 2A-2B. In some embodiments, performing one or more verification or testing operations includes performing timing verification or design validation. In some embodiments, method 900 further includes producing a fabrication data set for the first SOC using the first design database and transmitting the fabrication data set for the first SOC to a manufacturing system for manufacture of the first SOC, and performing the one or more verification or testing operations includes performing testing of the manufactured first SOC. Method 900 also includes, at block 950, producing an updated collection of design information incorporating one or more updates resulting from the one or more verification or testing operations.

Method 900 also includes (block 960) producing, from at least a subset of the updated collection of design information using a second configuration of parameters for at least a first portion of the updated collection of design information, a second netlist for the second SOC. Producing a netlist for the second SOC using design information updated through testing and verification during design of the first SOC may allow the second SOC's design process to benefit from the effort put into design of the first SOC. The method further includes (block 970) generating, using the second netlist, a second design database representing a second physical arrangement of circuit elements implementing the at least a subset of the plurality of components in the second SOC.

In some embodiments of method 900, the first physical arrangement includes one or more configuration circuits allowing changes to be made to the first SOC to implement in the first SOC the modification of at least a first component. In such an embodiment, an SOC design method may further include transmitting the first fabrication data set for the first SOC to a manufacturing system for manufacture of the first SOC, and using the one or more configuration circuits to modify a manufactured instance of the first SOC to produce a development SOC reflecting a component configuration of the second SOC. Such a development circuit may be used for development of a system incorporating the second SOC at a stage of the design process when the second SOC has not yet been manufactured.

In some embodiments of method 900, a first chip identifier reported by the first SOC in response to execution of a chip identifier software instruction has a same value as a second chip identifier reported by the second SOC in response to execution of the chip identifier software instruction. In some embodiments, the second physical arrangement includes a power domain partitioning, of the at least a subset of the plurality of the components, consistent with a power domain partitioning, of corresponding components of the first SOC, included in the first physical arrangement of the updated first design database. In some embodiments, the second physical arrangement provides for external connections, to circuitry implementing the at least a subset of the plurality of the components, in locations consistent with external connections, to circuitry implementing corresponding components of the first SOC, provided for by the first physical arrangement of the updated first design database.

In various embodiments, method 900 further includes producing one or both of a first fabrication data set for the first SOC or a second fabrication data set for the second SOC. Embodiments may further include transmitting one or both of the first fabrication data set and the second fabrication data set to an IC fabrication facility for fabrication of the first and/or second SOCs. In various embodiments method 900 may further include performing testing of one or both of the fabricated first and second SOCs. Embodiments may further include system development based on one or both of the first and second SOCs.

In addition to design methods such as methods 800 and 900, methods of fabricating SOCs belonging to an SOC family are also contemplated herein. In various embodiments, a fabrication method may include receiving one or both of a first fabrication data set and a second fabrication data set, where the first and second fabrication data set are produced as described in connection with methods 800 and 900, and elsewhere in this disclosure. Embodiments of the method may further include using the first or second fabrication data set to fabricate the first SOC or second SOC, respectively, or to use both data sets to fabricate both SOCs.

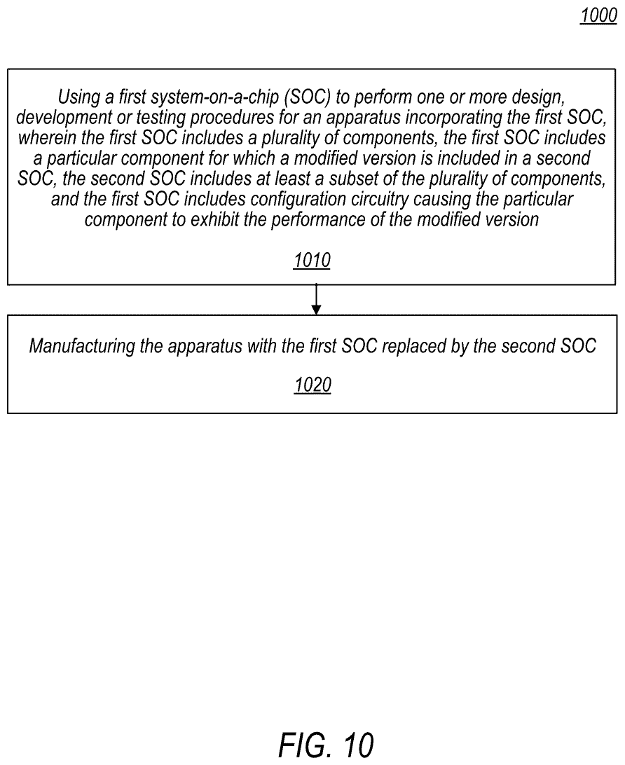

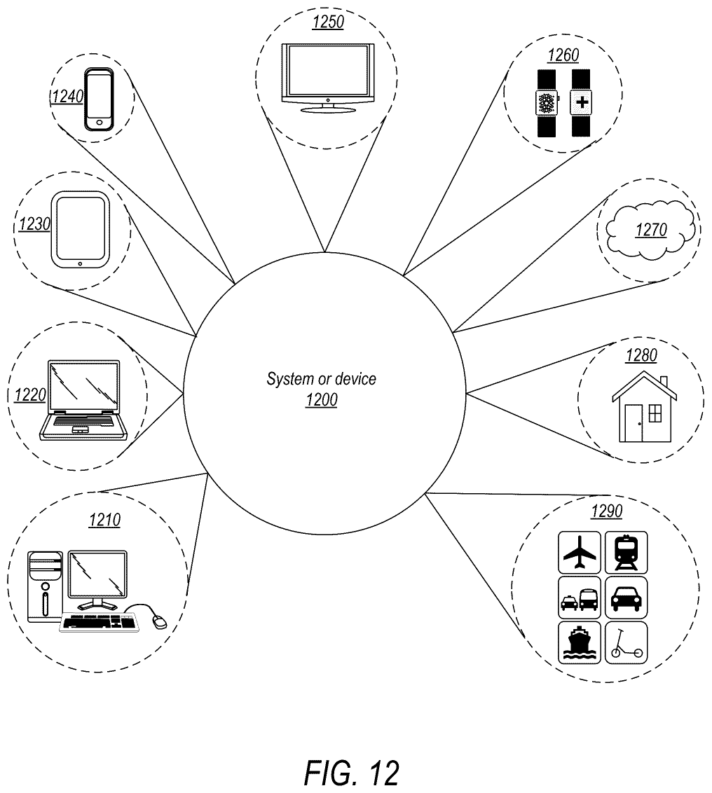

FIG. 10 is a flow diagram illustrating one embodiment of a design methodology for an apparatus incorporating an SOC. Other embodiments of a method may include more or fewer blocks than shown in FIG. 10. Method 1000 includes, at block 1010, using a first SOC to perform one or more design, development or testing procedures for an apparatus incorporating the first SOC. The first SOC includes a plurality of components, including a component for which a modified version is included in a second SOC. The second SOC includes at least a subset of the plurality of components, and the first SOC includes configuration circuitry causing the particular component to exhibit the performance of the modified version. An example of the first SOC described in method 1000 is SOC 500 of FIG. 5, configured as a development SOC such as that of column 708 of FIG. 7. An example of the second SOC described in method 1000 is SOC 400 of FIG. 4. Method 1000 further includes, at block 1020, manufacturing the apparatus with the first SOC replaced by the second SOC. Examples of an apparatus that may be manufactured using method 1000 include the systems described in connection with FIG. 12 below.

### Example Device

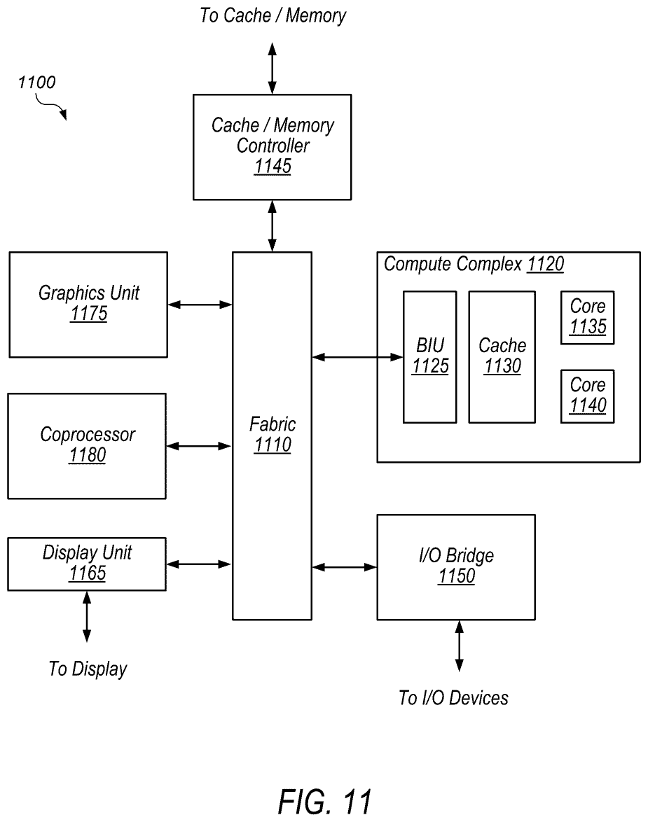

Referring now to FIG. 11, a block diagram illustrating an example embodiment of a device 1100 is shown. In some embodiments, elements of device 1100 may be included within a system on a chip as described herein. In some embodiments, device 1100 may be included in a mobile device, which may be battery-powered. Therefore, power consumption by device 1100 may be an important design consideration. In the illustrated embodiment, device 1100 includes fabric 1110, compute complex 1120, input/output (I/O) bridge 1150, cache/memory controller 1145, graphics unit 1175, coprocessor 1180 and display unit 1165. In some embodiments, device 1100 may include other components (not shown) in addition to or in place of the illustrated components, such as video processor encoders and decoders, image processing or recognition elements, computer vision elements, etc.

Fabric 1110 may include various interconnects, buses, MUX's, controllers, etc., and may be configured to facilitate communication between various elements of device 1100. In some embodiments, portions of fabric 1110 may be configured to implement various different communication protocols. In other embodiments, fabric 1110 may implement a single communication protocol and elements coupled to fabric 1110 may convert from the single communication protocol to other communication protocols internally.

In the illustrated embodiment, compute complex 1120 includes bus interface unit (BIU) 1125, cache 1130, and cores 1135 and 1140. In various embodiments, compute complex 1120 may include various numbers of processors, processor cores and caches. For example, compute complex 1120 may include 1, 2, or 4 processor cores, or any other suitable number. In one embodiment, cache 1130 is a set associative L2 cache. In some embodiments, cores 1135 and 1140 may include internal instruction and data caches. In some embodiments, a coherency unit (not shown) in fabric 1110, cache 1130, or elsewhere in device 1100 may be configured to maintain coherency between various caches of device 1100. BIU 1125 may be configured to manage communication between compute complex 1120 and other elements of device 1100. Processor cores such as cores 1135 and 1140 may be configured to execute instructions of a particular instruction set architecture (ISA) which may include operating system instructions and user application instructions. These instructions may be stored in computer readable medium such as a memory coupled to memory controller 1145 discussed below.

As used herein, the term “coupled to” may indicate one or more connections between elements, and a coupling may include intervening elements. For example, in FIG. 11, graphics unit 1175 may be described as “coupled to” a memory through fabric 1110 and cache/memory controller 1145. In contrast, in the illustrated embodiment of FIG. 11, graphics unit 1175 is “directly coupled” to fabric 1110 because there are no intervening elements.

Cache/memory controller 1145 may be configured to manage transfer of data between fabric 1110 and one or more caches and memories. For example, cache/memory controller 1145 may be coupled to an L3 cache, which may in turn be coupled to a system memory. In other embodiments, cache/memory controller 1145 may be directly coupled to a memory. In some embodiments, cache/memory controller 1145 may include one or more internal caches. Memory coupled to controller 1145 may be any type of volatile memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to controller 1145 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 1120 to cause the computing device to perform functionality described herein.

Graphics unit 1175 may include one or more processors, e.g., one or more graphics processing units (GPUs). Graphics unit 1175 may receive graphics-oriented instructions, such as OPENGL®, Metal®, or DIRECT3D® instructions, for example. Graphics unit 1175 may execute specialized GPU instructions or perform other operations based on the received graphics-oriented instructions. Graphics unit 1175 may generally be configured to process large blocks of data in parallel and may build images in a frame buffer for output to a display, which may be included in the device or may be a separate device. Graphics unit 1175 may include transform, lighting, triangle, and rendering engines in one or more graphics processing pipelines. Graphics unit 1175 may output pixel information for display images. Graphics unit 1175, in various embodiments, may include programmable shader circuitry which may include highly parallel execution cores configured to execute graphics programs, which may include pixel tasks, vertex tasks, and compute tasks (which may or may not be graphics-related).

One or more of coprocessor 1180 may be used to implement particular operations. In some embodiments coprocessor 1180 may implement particular operations more efficiently than a general-purpose processor. In various embodiments, coprocessors 1180 include optimizations and/or specialized hardware not typically implemented by core processors in compute complex 1120. In an embodiment, coprocessor 1180 implements vector and matrix operations.

Display unit 1165 may be configured to read data from a frame buffer and provide a stream of pixel values for display. Display unit 1165 may be configured as a display pipeline in some embodiments. Additionally, display unit 1165 may be configured to blend multiple frames to produce an output frame. Further, display unit 1165 may include one or more interfaces (e.g., MIPI® or embedded display port (eDP)) for coupling to a user display (e.g., a touchscreen or an external display).

I/O bridge 1150 may include various elements configured to implement: universal serial bus (USB) communications, security, audio, and low-power always-on functionality, for example. I/O bridge 1150 may also include interfaces such as pulse-width modulation (PWM), general-purpose input/output (GPIO), serial peripheral interface (SPI), and inter-integrated circuit (I2C), for example. Various types of peripherals and devices may be coupled to device 1100 via I/O bridge 1150.

In some embodiments, device 1100 includes network interface circuitry (not explicitly shown), which may be connected to fabric 1110 or I/O bridge 1150. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 1100 with connectivity to various types of other devices and networks.

Example Applications

Turning now to FIG. 12, various types of systems that may include any of the circuits, devices, or system discussed above are shown. System or device 1200, which may incorporate or otherwise utilize one or more of the techniques described herein, may be utilized in a wide range of areas. For example, system or device 1200 may be utilized as part of the hardware of systems such as a desktop computer 1210, laptop computer 1220, tablet computer 1230, cellular or mobile phone 1240, or television 1250 (or set-top box coupled to a television).

Similarly, disclosed elements may be utilized in a wearable device 1260, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 1200 may also be used in various other contexts. For example, system or device 1200 may be utilized in the context of a server computer system, such as a dedicated server or on shared hardware that implements a cloud-based service 1270. Still further, system or device 1200 may be implemented in a wide range of specialized everyday devices, including devices 1280 commonly found in the home such as refrigerators, thermostats, security cameras, etc. The interconnection of such devices is often referred to as the “Internet of Things” (IoT). Elements may also be implemented in various modes of transportation. For example, system or device 1200 could be employed in the control systems, guidance systems, entertainment systems, etc. of various types of vehicles 1290.

The applications illustrated in FIG. 12 are merely exemplary and are not intended to limit the potential future applications of disclosed systems or devices. Other example applications include, without limitation: portable gaming devices, music players, data storage devices, unmanned aerial vehicles, etc.

### Example Computer-Readable Medium

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as: design simulation, design synthesis, circuit fabrication, etc.

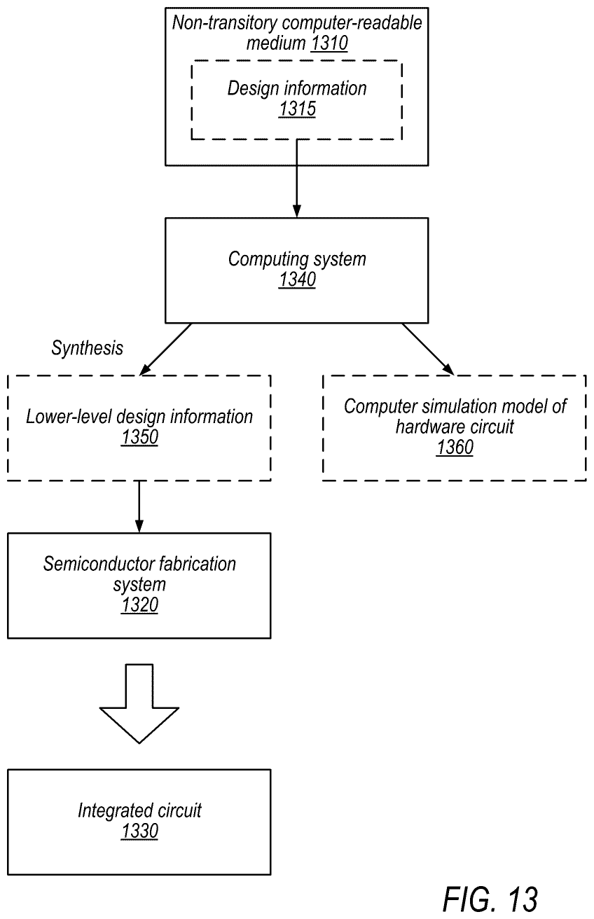

FIG. 13 is a block diagram illustrating an example non-transitory computer-readable storage medium that stores circuit design information, according to some embodiments. In the illustrated embodiment, computing system 1340 is configured to process the design information. This may include executing instructions included in the design information, interpreting instructions included in the design information, compiling, transforming, or otherwise updating the design information, etc. Therefore, the design information controls computing system 1340 (e.g., by programming computing system 1340) to perform various operations discussed below, in some embodiments.

In the illustrated example, computing system 1340 processes the design information to generate both a computer simulation model 1360 of a hardware circuit and lower-level design information 1350. In other embodiments, computing system 1340 may generate only one of these outputs, may generate other outputs based on the design information, or both. Regarding the computing simulation, computing system 1340 may execute instructions of a hardware description language that includes register transfer level (RTL) code, behavioral code, structural code, or some combination thereof. The simulation model may perform the functionality specified by the design information, facilitate verification of the functional correctness of the hardware design, generate power consumption estimates, generate timing estimates, etc.

In the illustrated example, computing system 1340 also processes the design information to generate lower-level design information 1350 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Computing system 1340 may use computer simulation model 1360 in generating lower-level design information 1350 in some embodiments. Based on lower-level design information 1350 (potentially among other inputs), semiconductor fabrication system 1320 is configured to fabricate an integrated circuit 1330 (which may correspond to functionality of the simulation model 1360). Note that computing system 1340 may generate different simulation models based on design information at various levels of description, including information 1350, 1315, and so on. The data representing design information 1350 and model 1360 may be stored on medium 1310 or on one or more other media.

In some embodiments, the lower-level design information 1350 controls (e.g., programs) the semiconductor fabrication system 1320 to fabricate the integrated circuit 1330. Thus, when processed by the fabrication system, the design information may program the fabrication system to fabricate a circuit that includes various circuitry disclosed herein.

Non-transitory computer-readable storage medium 1310, may comprise any of various appropriate types of memory devices or storage devices. Non-transitory computer-readable storage medium 1310 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Non-transitory computer-readable storage medium 1310 may include other types of non-transitory memory as well or combinations thereof. Accordingly, non-transitory computer-readable storage medium 1310 may include two or more memory media; such media may reside in different locations—for example, in different computer systems that are connected over a network.

Design information 1315 may be specified using any of various appropriate computer languages, including hardware description languages such as, without limitation: VHDL, Verilog, SystemC, SystemVerilog, RHDL, M, MyHDL, etc. The format of various design information may be recognized by one or more applications executed by computing system 1340, semiconductor fabrication system 1320, or both. In some embodiments, design information may also include one or more cell libraries that specify the synthesis, layout, or both of integrated circuit 1330. In some embodiments, the design information is specified in whole or in part in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 1330 may, in various embodiments, include one or more custom macrocells, such as memories, analog or mixed-signal circuits, and the like. In such cases, design information may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 1320 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 1320 may also be configured to perform various testing of fabricated circuits for correct operation.

In various embodiments, integrated circuit 1330 and model 1360 are configured to operate according to a circuit design specified by design information 1315, which may include performing any of the functionality described herein. For example, integrated circuit 1330 may include any of various elements shown in FIGS. 1 and 3-5. Further, integrated circuit 1330 may be configured to perform various functions described herein in conjunction with other components. Further, the functionality described herein may be performed by multiple connected integrated circuits.

As used herein, a phrase of the form “design information that specifies a design of a circuit configured to . . .” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model” does not imply that the instructions must be executed in order for the element to be met, but rather specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by the design information. The different circuit implementations may affect the performance, area, power consumption, etc. of a given design (potentially with tradeoffs between different design goals), but the logical function does not vary among the different circuit implementations of the same circuit design.

In some embodiments, the instructions included in the design information instructions provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information. The lower-level design information may program fabrication system 1320 to fabricate integrated circuit 1330.

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels”may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to”perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to”perform the particular function.

For purposes of United States patent applications based on this disclosure, reciting in a claim that a structure is “configured to” perform one or more tasks is expressly intended not to invoke 35 U.S. C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used transform the structure of a circuit, unit, or component to the next level of implementational detail.

Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

Numerous variations and modifications will become apparent to those skilled in the art once the above disclosure is fully appreciated. It is intended that the following claims be interpreted to embrace all such variations and modifications.

What is claimed is:

1. A method comprising:
Defining representations of a plurality of components for a first system-on-a-chip (SOC) in a collection of design information, wherein at least a portion of the collection of design information is parameterized to allow specification of a modification, in a second SOC including at least a subset of the plurality of components, of at least a first component of the plurality of components;
producing, from the collection of design information using a first configuration of parameters for the at least a portion of the collection of design information, a first netlist for the first SOC;
generating, using the first netlist, a first design database representing a first physical arrangement of circuit elements implementing the plurality of components in the first SOC;
using one or more of the collection of design information, the first netlist or the first design database, performing one or more verification or testing operations;
producing an updated collection of design information incorporating one or more updates resulting from the one or more verification or testing operations;
producing, from at least a subset of the updated collection of design information using a second configuration of parameters for at least a portion of the updated collection of design information, a second netlist for the second SOC; and
generating, using the second netlist, a second design database representing a second physical arrangement of circuit elements implementing the at least a subset of the plurality of components in the second SOC.

2. The method of claim 1, wherein the modification of at least a first component includes a reduction in an amount of memory.

3. The method of claim 1, wherein the modification of at least a first component includes a reduction in a number of processor cores.

4. The method of claim 1, wherein the first physical arrangement includes one or more configuration circuits allowing changes to be made to the first SOC to implement in the first SOC the modification of at least a first component.

5. The method of claim 1, wherein performing one or more verification or testing operations includes performing timing verification or design validation.

6. The method of claim 1, further comprising:
producing a fabrication data set for the first SOC using the first design database; and
transmitting the fabrication data set for the first SOC to a manufacturing system for manufacture of the first SOC.

7. The method of claim 6, wherein performing the one or more verification or testing operations includes performing testing of the manufactured first SOC.

8. The method of claim 1, further comprising:
producing a fabrication data set for the second SOC using the second design database; and
transmitting the fabrication data set for the second SOC to a manufacturing system for manufacture of the second SOC.

9. An integrated circuit produced by the method of claim 8.

10. An integrated circuit, comprising:
first circuitry implementing a first component of a system-on-a-chip (SOC), wherein the first component is a modified version of a second component included in a different integrated circuit; and
additional circuitry implementing a first set of additional components forming a least a subset of a second set of additional components included in the different integrated circuit; and
a stored first chip identifier matching a second chip identifier stored by the different integrated circuit.

11. The integrated circuit of claim 10, further comprising a first power domain partitioning of the first component and the first set of additional components, wherein the first power domain partitioning is consistent with a second power domain partitioning, in the different integrated circuit, of the second component and the second set of additional components.

12. The integrated circuit of claim 10, further comprising a first set of external connections to the first circuitry and the additional circuitry, wherein physical locations on the integrated circuit of the first set of external connections are consistent with physical locations on the different integrated circuit of a second set of external connections to circuitry implementing the second component and the second set of additional components.

13. The integrated circuit of claim 10, wherein:
the integrated circuit is initialized using first boot-up instructions stored on a read-only memory (ROM); and
the first boot-up instructions match second boot-up instructions for the different integrated circuit.

14. The integrated circuit of claim 10, further comprising an interconnection fabric connecting the first component and first set of additional components, wherein
the interconnection fabric is configured to interconnect a superset of the first component, second component, first set of additional components and second set of additional components; and
a memory map implemented by the integrated circuit maintains an address for each component in the superset interconnected by the interconnection fabric.

15. The integrated circuit of claim 10, wherein:
the second component is a second group of encoder or decoder circuits; and
the first component is a first group of encoder or decoder circuits including fewer encoder or decoder circuits than the second group of encoder or decoder circuits.

16. A method, comprising:
defining representations of a plurality of components for a first system-on-a-chip (SOC) in a collection of design information, wherein at least a first component of the plurality of components is modified for inclusion in a second SOC that includes at least a subset of the plurality of components, and wherein at least a portion of the collection of design information is parameterized to reflect the first component in the first SOC and the modified first component in the second SOC;
producing, from the collection of design information using a first configuration of parameters for the at least a portion of the collection of design information, a first netlist for the first SOC;
producing, from at least a subset of the collection of design information using a second configuration of parameters for the at least a portion of the collection of design information, a second netlist for the second SOC;
generating, using the first netlist, a first design database representing a first physical arrangement of circuit elements implementing the plurality of components in the first SOC;
generating, using the second netlist, a second design database representing a second physical arrangement of circuit elements implementing the at least a subset of the plurality of components in the second SOC; and
producing a first fabrication data set for the first SOC based on the first design database and a second fabrication data set for the second SOC based on the second design database, wherein a power domain partitioning from the first SOC is retained in the second SOC.

17. The method of claim 16, wherein a first chip identifier reported by the first SOC in response to execution of a chip identifier software instruction has a same value as a second chip identifier reported by the second SOC in response to execution of the chip identifier software instruction.

18. The method of claim 16, wherein the first component is a memory circuit, and the modified first component has a smaller storage capacity than the first component.

19. The method of claim 16, wherein the first physical arrangement includes one or more configuration circuits allowing changes to be made to the first SOC to implement in the first SOC the modified first component.

20. The method of claim 19, further comprising:
transmitting the first fabrication data set for the first SOC to a manufacturing system for manufacture of the first SOC; and
using the one or more configuration circuits to modify a manufactured instance of the first SOC to produce a development SOC reflecting a component configuration of the second SOC.
